(19) United States
(12) Patent Application Publication
(10) Pub. No.: US 2007/0196761 A1
(43) Pub. Date: Aug. 23, 2007

(54) Barrier rib and black top for plasma display panel and method of fabricating the same

(75) Inventors: Hong Cheol Lee, Masan-Si (KR); Dae Hyun Park, Yongin-Si (KR); Je Seok Kim, Anyang-Si (KR); Byung Gil Ryu, Seoul (KR)

Correspondence Address: BIRCH STEWART KOLASCH & BIRCH, PO BOX 747, FALLS CHURCH, VA, 22040-0747, US

(73) Assignee: LG Electronics Inc., Seoul (KR)

(21) Appl. No.: 11/700,775

(22) Filed: Feb. 1, 2007

(30) Foreign Application Priority Data
Feb. 1, 2006 (KR) 10-2006-0009598

(51) Int. Cl. H01J 9/227

(52) U.S. Cl. 430/198; 430/321; 430/270.1; 430/281.1; 430/945

(57) ABSTRACT

A method of fabricating barrier ribs and black tops for a plasma display panel including sequentially laminating a photosensitive barrier rib material and a photosensitive black top material on a substrate, simultaneously exposing and developing the photosensitive black top material and the photosensitive barrier rib material in a predetermined pattern using a laser direct imaging process, and burning the developed pattern to thereby form the barrier ribs and black tops.

This invention claims priority to Korean Application No. 10-2006-0009598 filed in Korea on Feb. 1, 2006, the entire contents of which are hereby incorporated in their entirety.

### BACKGROUND OF THE INVENTION

1. Field of the Invention

The present invention relates to barrier ribs and black tops for a plasma display panel and corresponding method of fabricating the same using a direct exposure process.

2. Description of the Related Art

A plasma display panel (PDP) electrically discharges He+Xe or Ne+Xe gases to produce UV light having a wavelength of approximately 147 nm. The UV light is then used to excite phosphors, thereby realizing images such as characters or graphics. For example, FIG. 1 is a perspective view illustrating a related art surface discharge type AC PDP.

As illustrated in FIG. 1, the AC PDP includes a lower glass substrate 14 having address electrodes 2 mounted thereon and an upper glass substrate 16 having a pair of transparent electrodes 4 mounted on a bottom surface of the upper glass substrate 16. Further, a lower dielectric layer 18 for forming wall charges and barrier ribs 8 for sectioning discharge cells are sequentially formed on the lower glass substrate 14 having the mounted electrodes 2.

In addition, a phosphor layer 6 is applied on the surface of the lower dielectric layer 18 and the barrier ribs 8. The phosphor layer 6 is excited by UV light that is generated upon the electrical discharge of plasma, thus producing visible light. Further, an upper dielectric layer 12 and a protective film 10 are sequentially formed arc formed on the upper glass substrate 16 having the pair of transparent electrodes 4. Similar to the lower dielectric layer 18, the upper dielectric layer 12 is used to form wall charges, and the protective film 10 is used to protect the upper dielectric layer 12 from sputtered gas ions upon the electrical discharge of plasma.

Also, the AC PDP includes discharge cells formed by spacing the lower and upper glass substrates 14, 16 apart from each other by the barrier ribs 8. Further, the discharge cells are sealed in a state in which they are filled with a gas mixture of He+Xe or Ne+Xe. In addition, the barrier ribs 8 are used to prevent electrical or optical crosstalk among the discharge cells. Also, black tops (not shown) may be formed on the barrier ribs 8 to effectively absorb external light. Hereinafter, the barrier ribs and the black tops will be referred to as separate constituents. The barrier ribs and the black tops mentioned are used to realize a desired display quality and luminous efficiency.

Turning next to FIGS. 2 and 3A-3F. In more detail, FIG. 2 is a flowchart illustrating a related art method of fabricating barrier ribs and black tops, and FIGS. 3A to 3F are cross-sectional views sequentially illustrating the fabrication method of FIG. 2.

As shown in FIGS. 2 and 3(a) and 3(b), the method includes sequentially laminating a barrier rib sheet 8a and a black top sheet 9a (S10 and S12), both of which are non-photosensitive. Then the barrier rib sheet 8a and the black top sheet 9 are burned, and coated with a photosensitive photoresist layer 15 (S14 and S16). Subsequently, exposure and development are conducted using a photomask 15a having a desired pattern and UV light at 365 nm (S18 and S20). See also FIGS. 3(c) and 3(d). Then, an etching and stripping process are performed, thereby forming the barrier ribs 8 and black tops 9 (S22-S26). See also FIGS. 3(e) and 3(f).

In addition, the etching process is used to form the barrier ribs 8 and the black tops 9 of the lower glass substrate 14. Thus, as shown in FIGS. 3(b)-3(e), the processes of applying, exposing and stripping the photoresist layer 15 are required. Further, because the photomask 15a is also required, it is difficult to manufacture a large-sized panel. In particular, because the photoresist layer 15 is removed via a wet process using an alkali solution, impure gases in the discharge section are generated due to the permeation of moisture and alkali ions into the barrier ribs. Therefore, the fabrication process is complicated, which increases the fabrication cost and decreases the yield.

### SUMMARY OF THE INVENTION

Accordingly, one object of the present invention is to address the above-noted and other problems.

Another object of the present invention is to provide a method of fabricating barrier ribs and black tops for a PDP using an LDI process, in place of an etching process, thus decreasing the number of processes and cost for fabricating the barrier ribs and black tops.

To achieve these and other advantages and in accordance with the purpose of the present invention, as embodied and broadly described herein, the present invention provides in one aspect a method of fabricating barrier ribs and black tops for a plasma display panel including sequentially laminating a photosensitive barrier rib material and a photosensitive black top material on a substrate, simultaneously exposing and developing the photosensitive black top material and the photosensitive barrier rib material in a predetermined pattern using a laser direct imaging process, and burning the developed pattern to thereby form the barrier ribs and black tops.

In another aspect, the present invention provides barrier ribs including a laser-direct-imaged photosensitive barrier rib material layer formed in a predetermined pattern on a glass substrate, and black tops including a laser-direct-imaged photosensitive black top material layer formed on the photosensitive barrier rib material layer.

In yet another aspect, the present invention provides a composition for barrier ribs and black tops for a plasma display panel. The composition includes a photosensitizer for light direct imaging including a photoinitiator, and an inorganic pigment.

Further scope of applicability of the present invention will become apparent from the detailed description given hereinafter. However, it should be understood that the detailed description and specific examples, while indicating preferred embodiments of the invention, are given by illustration only, since various changes and modifications within the spirit and scope of the invention will become apparent to those skilled in the art from this detailed description.

### BRIEF DESCRIPTION OF THE DRAWINGS

The above and other objects, features and other advantages of the present invention will be more clearly understood from the following detailed description when taken in conjunction with the accompanying drawings, in which:

FIG. 1 is a perspective view illustrating a surface discharge type AC PDP;

FIG. 2 is a flowchart illustrating a related art process of forming barrier ribs using an etching process;

FIGS. 3A to 3F are sectional views sequentially illustrating the process of forming the barrier ribs of FIG. 2;

FIGS. 4A and 4B are overviews illustrating exposure devices that do not use a photomask;

FIG. 5 is a flowchart illustrating a process of forming barrier ribs and black tops for a PDP according to an embodiment of the present invention;

FIGS. 6A to 6C are sectional views sequentially illustrating the process of forming the barrier ribs and the black tops of FIG. 5;

FIGS. 7A and 7B are sectional views illustrating the barrier rib material and the black top material, respectively, used in the present invention; and

FIG. 8 is a graph illustrating the absorption waveform of a photoinitiator for the LDI used in the present invention.

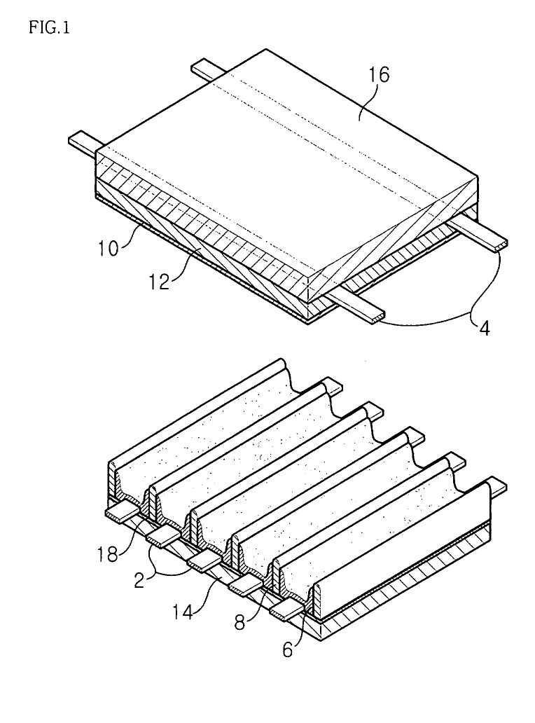

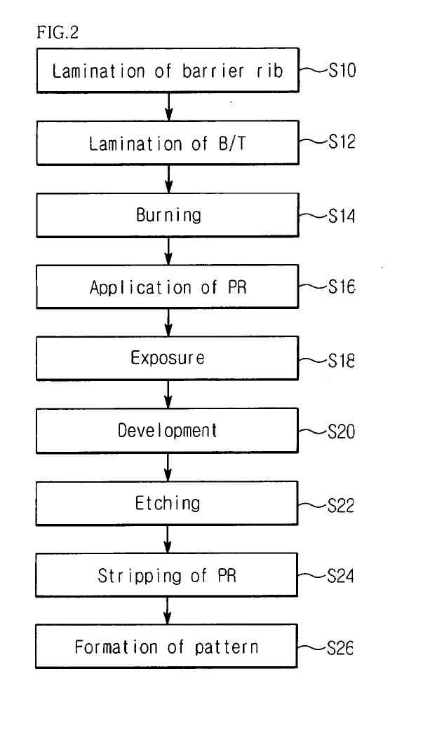

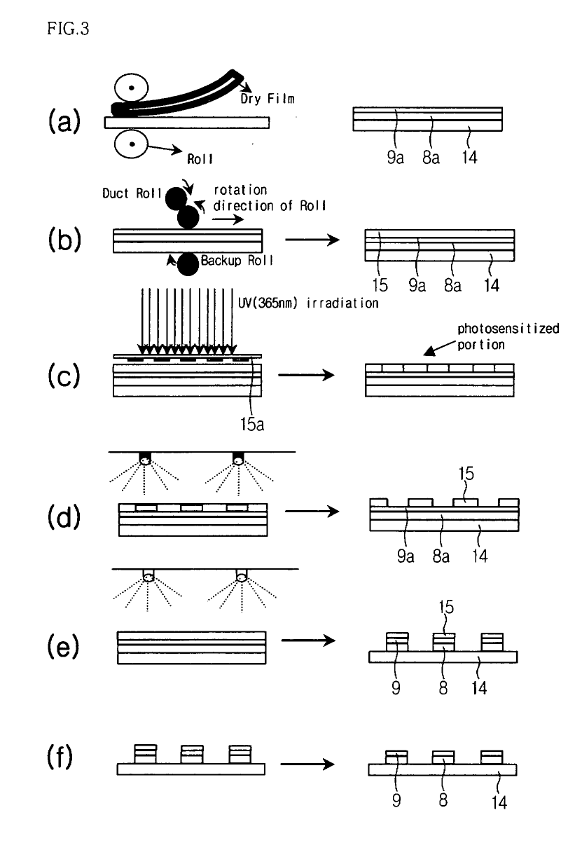

### DESCRIPTION OF THE PREFERRED EMBODIMENTS

Reference will now be made in detail to the preferred embodiments of the present invention, examples of which are illustrated in the accompanying drawings.

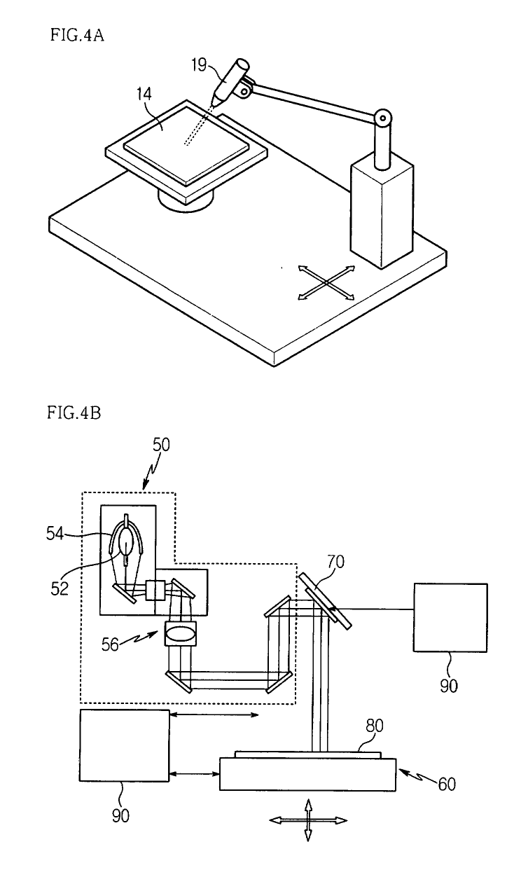

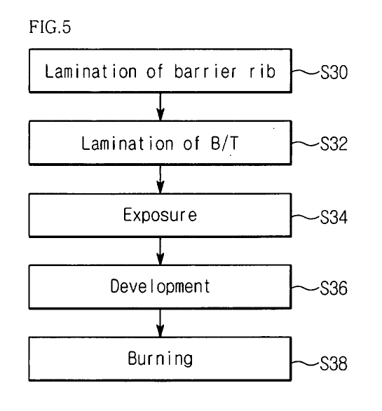

Turning first to FIG. 4A, which is an overview illustrating a first type of exposure device that does not use a photomask. In more detail, the art exposure device shown in FIG. 4A includes exclusively a laser generator 19, and does not use both a photomask and an optical system compared to general exposure devices. Hereinafter, a laser exposure process that does not use a photomask is referred to as laser direct imaging (LDI).

In addition, the laser generator 19 directly applies a laser beam onto a substrate using CAD (Computer Automated Design) data for pattern design. Further, the laser beam is radiated onto the substrate 14 coated with photosensitive material in the form of a line, thus completing a predetermined pattern. In such an LDI process, a laser beam having a small irradiation area is applied onto a substrate in the form of a line, and thus the above exposure device is particularly useful for exposing a small area of a substrate.

Next, FIG. 4B is an overview illustrating a second type of exposure device that does not use a photomask. As shown in FIG. 4B, this exposure device includes an optical system 50 for collimating UV light, a digital micro device (DMD) 70 for selectively reflecting UV light output from the optical system to produce a pattern on a substrate 80, which is the object of the exposure process, and a base assembly 60 for exposing the substrate to UV light supplied from the DMD 70.

Further, the optical system includes a very high pressure mercury lamp 52 and a condensing mirror 54 for emitting UV light in a predetermined direction, and a mirror assembly 56 having a plurality of mirrors and lenses for reflecting UV light, which is generated from the mercury lamp, several times to thereby collimate it. In addition, the DMD 70 includes a plurality of cells, each having a reflective plate able to control the angle of reflection using a control part 90 and a driving mechanism.

Thus, because the cells are individually operated, the UV light transferred via the mirror assembly 56 is selectively reflected so that a predetermined pattern is formed on the substrate. Therefore, it is possible to radiate UV light having a larger irradiation area onto a substrate, which decreases the cost and time required for the exposure process.

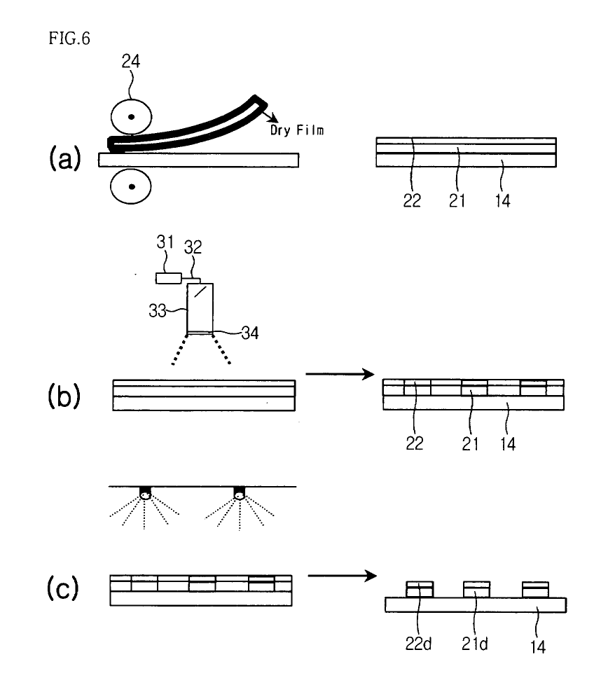

Turning next to FIG. 5, which is a flowchart illustrating the process of fabricating barrier ribs and black tops for a PDP according to an embodiment of the present invention. As shown, the fabrication process includes sequentially laminating barrier ribs and black tops (S30 and S32), followed by an exposure, development and burning process (S34, S36 and S38). FIGS. 6(a)-6(c) are sectional views sequentially illustrating the process of fabricating the barrier ribs and the black tops of FIG. 5.

In more detail, as shown in FIG. 6(a), a photosensitive barrier rib material 21 and a photosensitive black top material 22 are sequentially laminated on a lower glass substrate 14. Further, the glass substrate 14 includes elements used for driving a panel. For example, the substrate 14 includes address electrodes and a dielectric layer. In addition, although the photosensitive barrier rib material 21 and the photosensitive black top material 22 may be provided in the form of a green sheet, the materials may be provided in the form of a paste such as a photosensitive coating solution.

Next, as shown in FIGS. 6(b) and 6(c), the photosensitive black top material 22 and the photosensitive barrier rib material 21 are simultaneously exposed according to a predetermined pattern using an LDI process and a DMD. The substrate is then developed according to the exposed pattern. In addition, during the development process, portions other than the exposed portion are formed into barrier ribs 21d and black tops 22d, followed by a burning process, thereby completing the fabrication of the barrier ribs 21d and black tops 22d.

In addition, the above-referenced drawing illustrates the process of laminating the photosensitive barrier rib material and the photosensitive black top material using green sheets. However, as discussed above, the photosensitive barrier rib material and the photosensitive black top material may be realized by applying a paste.

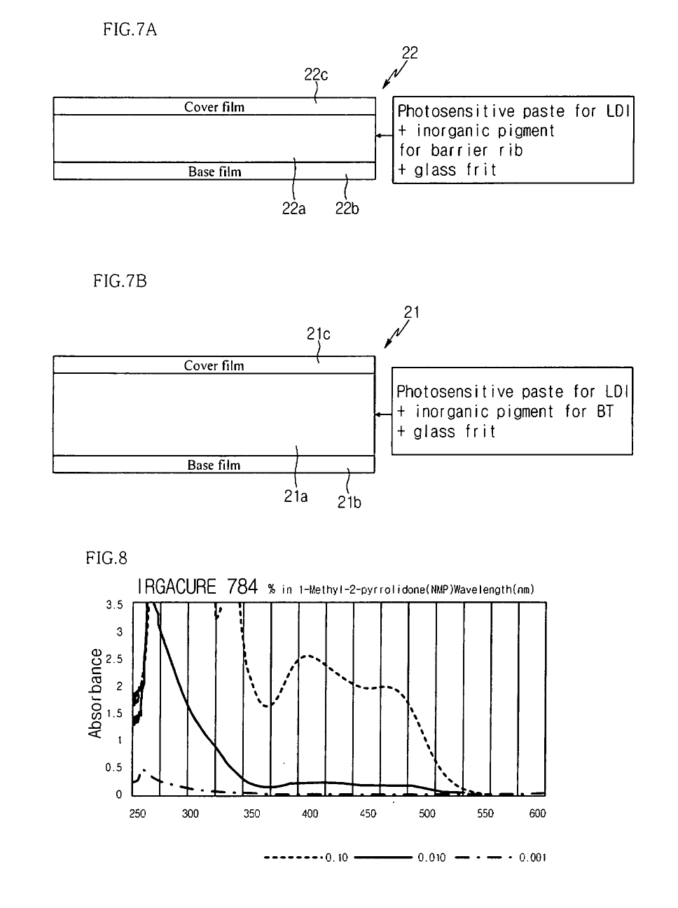

Next, FIGS. 7A and 7B are sectional views illustrating the photosensitive barrier rib material and the photosensitive black top material used in the fabrication process of the present invention, respectively. As shown in FIG. 7B, the photosensitive barrier rib material 21 includes a photosensitive barrier rib material layer 21a composed of a photosensitizer for LDI, an inorganic pigment for a barrier rib, and glass frit. In addition, a cover film 21c and a base film 21b are respectively applied on top and bottom surfaces of the material layer 21a. In addition, as shown in FIG. 7A, the photosensitive black top material 22 includes a photosensitive black top material layer 22a composed of a photosensitizer for LDI, an inorganic pigment for a black top, and glass frit. Also, a cover film 22c and a base film 22b are respectively applied on top and bottom surfaces of the material layer 22b.

In addition, the photosensitive barrier rib black top material laminated in the present invention are much thicker than the photoresist typically used in LDI. Thus, in order to thoroughly photosensitize a thick layer (100 μm or thicker) with UV light using an LDI process, two methods of the present invention are presented.

In more detail, one method includes the addition of a multifunctional (i.e., a trifunctional or greater) monomer to a photopolymerization monomer to increase reactivity. The other method includes the use of a photoinitiator for initiating photopolymerization at a sharp wavelength of 405 nm. The photoinitiator and monomer exemplified below effectively expose the photosensitive barrier rib material and the black top material of the present invention.

Further, according to an embodiment of the present invention, the photosensitizer used in the photosensitive barrier rib material 21 and the photosensitive black top material 22 includes a base polymer, a photoinitiator and a photopolymerization monomer. The individual components are described in detail below.

Examples of the base polymer used in the present invention include methacrylic copolymer, acrylic resin such as acrylic copolymer containing an acetoacetyl group, polyester resin, and polyurethane resin, as in the composition of a typical photosensitive paste. The methacrylic copolymer is obtained by copolymerizing those selected from among methacrylic polymers including methylmethacrylate, ethylmethacrylate, propylmethacrylate, butylmethacrylate, hexylmethacrylate, 2-ethylhexyl methacrylate, cyclohexyl methacrylate, dimethylaminoethyl methacrylate, hydroxyethyl methacrylate, hydroxypropyl methacrylate, and glycidyl methacrylate. In addition, the methacrylic copolymer may be copolymerized with ethylenically unsaturated carboxylic acid or other polymers, if necessary.

Specific examples of the ethylenically unsaturated carboxylic acid include monoacrylic acid, such as acrylic acid, methacrylic acid, and crotonic acid, dicarboxylic acid, such as maleic acid, fumaric acid, and itaconic acid, anhydrides thereof, and half-ester polymers.

In addition, the photopolymerization monomer included in the photosensitizer according to an embodiment of the present invention preferably includes a multifunctional (i.e., a trifunctional or greater) monomer. This is because, when a typical photosensitizer composed of a monofunctional monomer or a multifunctional monomer including a bifunctional monomer or some trifunctional monomers is used for the thick barrier rib material (100 μm or thicker) including a white barrier rib and a black layer, the reactivity to UV light is decreased and thus the barrier rib material is not thoroughly exposed up to the lower end thereof.

Therefore, to increase the reactivity to UV light to thereby sufficiently expose the barrier rib material up to the lower end thereof, the multifunctional (i.e., trifunctional or greater) monomer is exemplified by trimethylolpropane triacrylate, dipentaerythritol pentaacrylate, pentaerythritol tetraacrylate, dipentaerythritol hexaacrylate, ditrimethylolpropane tetraacrylate, and pentaerythritol ethoxylated tetraacrylate.

In addition, the photoinitiator used in the photosensitizer for LDI includes any photoinitiator which satisfies conditions suitable for initiating photopolymerization at a sharp wavelength of 405 nm. Specific examples include Irgacure 784, available from Ciba Company. For example, FIG. 8 is a graph showing the absorbance of the photoinitiator for LDI using Irgacure 784 available from Ciba Company. In addition, the structure of Irgacure 784, available from Ciba Company, is represented by Formula 1 below:

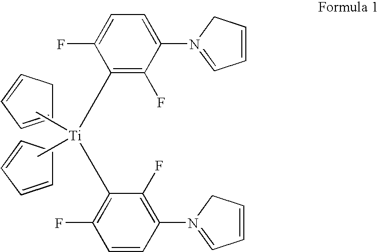

The process of fabricating the barrier ribs and black tops for the PDP according to an embodiment of the present invention will now be described in detail with reference to FIGS. 6(a)-(c). That is, in the lamination step illustrated in FIG. 6(a), the photosensitive barrier rib material 21 and the photosensitive black top material 22 in the form of a dry film are sequentially laminated on the substrate 14 using laminating rolls 24, thus forming a photosensitive barrier rib layer and a photosensitive black top layer.

In the exposure step illustrated in FIG. 6(b), light is emitted to a DMD 33 via an optical fiber 32 from a laser diode (LD) light source 31. While the reflective plates provided in individual cells of the DMD are controlled using an embedded driving mechanism, the laser light is radiated on the desired region of a substrate using the DMD 33 and a projection lens 34, so that the barrier rib material 21 and the black top material 22 are exposed according to a predetermined pattern. Further, in such an exposure step, because the exposure process for LDI and the DMD are used, a photomask is not needed, thus preventing the deterioration of performance occurring upon removal of a related art photoresist PR.

Also, in the development and burning step illustrated in FIG. 6(c), portions other than the exposed portion are developed to thus form barrier ribs 21d and black tops 22d. The barrier ribs 21d and black tops 22d thus formed are burned, thereby completing the fabrication process.

In this way, the barrier ribs and the black tops of the present invention can be formed using only the exposure and development steps after the lamination, thus decreasing the cost and the number of processes. Further, after the lamination step, the exposure and development steps can be simultaneously conducted, and thus the barrier ribs and the black tops can be formed at the same time. Therefore, the cost and the number of processes are decreased.

In addition, in accordance with an embodiment of the present invention, the deterioration of performance occurring upon the removal of the photoresist as in the related art can be prevented, resulting in an improved performance. In particular, according to the method of forming the barrier ribs and the black tops for the PDP of the present invention, the exposure process for LDI and the DMD are used, and therefore there is no need for a photomask, resulting in the realization of a large size and high definition display.

As described hereinbefore, the present invention provides barrier ribs and black tops for a PDP and a method of fabricating the same. According to the present invention, because an LDI process is employed, the use of a photomask for exposure and development is eliminated. Thus, because there is no need for the photomask, the number of fabrication processes is decreased, thus decreasing the process expense and fabrication cost and realizing a large size and high definition display. Therefore, the method of fabricating the barrier ribs and the black tops for the PDP of the present invention greatly increases the patternability and yield while decreasing the price and the number of processes.

As the present invention may be embodied in several forms without departing from the spirit or essential characteristics thereof, it should also be understood that the above-described embodiments are not limited by any of the details of the foregoing description, unless otherwise specified, but rather should be construed broadly within its spirit and scope as defined in the appended claims, and therefore all changes and modifications that fall within the metes and bounds of the claims, or equivalence of such metes and bounds are therefore intended to be embraced by the appended claims.

What is claimed is:

1. A method of fabricating barrier ribs and black tops for a plasma display panel, the method comprising:
sequentially laminating a photosensitive barrier rib material and a photosensitive black top material on a substrate;
simultaneously exposing and developing the photosensitive black top material and the photosensitive barrier rib material in a predetermined pattern using a laser direct imaging process; and
burning the developed pattern to thereby form the barrier ribs and black tops.

2. The method of claim 1, wherein the photosensitive barrier rib material and the photosensitive black top material are provided in a form of a green sheet or a paste.

3. The method of claim 1, wherein each of the photosensitive barrier rib material and the photosensitive black top material comprises a photoinitiator for initiating photopolymerization at a wavelength of approximately 405 nm.

4. The method of claim 1, wherein each of the photosensitive barrier rib material and the photosensitive black top material comprises a multifunctional monomer, which is trifunctional or greater.

5. The method of claim 4, wherein the multifunctional monomer, which is trifunctional or greater, is any one selected from among trimethylolpropane triacrylate, dipentaerythritol pentaacrylate, pentaerythritol tetraacrylate, dipentaerythritol hexaacrylate, and ditrimethylolpropane tetraacrylate.

6. The method of claim 1, wherein the photosensitive barrier rib material comprises a photosensitive barrier rib material layer composed of a photosensitizer for laser direct imaging, an inorganic pigment for a barrier rib, and glass frit, and a cover film and a base film respectively formed thereon and therebeneath.

7. The method of claim 1, wherein the photosensitive black top material comprises a photosensitive black top material layer composed of a photosensitizer for laser direct imaging, an inorganic pigment for a black top, and glass frit, and a cover film and a base film respectively formed thereon and therebeneath.

8. The method of claim 1, wherein the laser direct imaging process is performed using a digital micro device.

9. Barrier ribs and black tops for a plasma display panel, comprising:
barrier ribs including a laser-direct-imaged photosensitive barrier rib material layer formed in a predetermined pattern on a glass substrate; and
black tops including a laser-direct-imaged photosensitive black top material layer formed on the photosensitive barrier rib material layer.

10. The barrier ribs and black tops of claim 9, wherein the laser-direct-imaged barrier ribs and black tops comprise a laser-direct-imaged green sheet or paste.

11. The barrier ribs and black tops of claim 9, wherein each of the photosensitive barrier rib material layer and the photosensitive black top material layer comprises a photoinitiator for initiating photopolymerization at a wavelength of approximately 405 nm.

12. The barrier ribs and black tops of claim 9, wherein each of the photosensitive barrier rib material layer and the photosensitive black top material layer comprises a multifunctional monomer, which is trifunctional or greater.

13. The barrier ribs and black tops of claim 12, wherein the multifunctional monomer, which is trifunctional or greater, is any one selected from among trimethylolpropane triacrylate, dipentaerythritol pentaacrylate, pentaerythritol tetraacrylate, dipentaerythritol hexaacrylate, and ditrimethylolpropane tetraacrylate.

14. The barrier ribs and black tops of claim 9, wherein the laser-direct-imaged barrier ribs comprise a laser-direct-imaged barrier rib material layer composed of a photosensitizer for laser direct imaging, an inorganic pigment for barrier ribs, and glass frit, and a cover film and a base film respectively formed thereon and therebeneath.

15. The barrier ribs and black tops of claim 9, wherein the laser-direct-imaged black tops comprise a laser-direct-imaged black top material layer composed of a photosensitizer for laser direct imaging, an inorganic pigment for black tops, and glass frit, and a cover film and a base film respectively formed thereon and therebeneath.

16. A composition for barrier ribs and black tops for a plasma display panel, said composition comprising:
a photosensitizer for light direct imaging including a photoinitiator, and an inorganic pigment.

17. The composition of claim 16, wherein the composition is provided in a form of a green sheet or in a paste.

18. The composition of claim 16, wherein the photoinitiator is used to initiate photopolymerization at a wavelength of a laser light source.

19. The composition of claim 18, wherein the wavelength is approximately 405 nm.

20. The composition of claim 16, wherein the photosensitizer for light direct imaging further comprises a multifunctional monomer, which is trifunctional or greater.

21. The composition of claim 20, wherein the multifunctional monomer, which is trifunctional or greater, is any one selected from among trimethylolpropane triacrylate, dipentaerythritol pentaacrylate, pentaerythritol tetraacrylate, dipentaerytnritol hexaacrylate, and ditrimethylolpropane tetraacrylate.
